(19) United States
(12) Patent Application Publication
(10) Pub. No.: US 2023/0155431 A1
(43) Pub. Date: May 18, 2023

(54) MOTOR

(71) Applicant: Nidec Corporation, Kyoto (JP)

(72) Inventors: Kentaro SATO, Kyoto (JP); Takahiro UETANI, Kyoto (JP)

(21) Appl. No.: 17/915,134

(22) PCT Filed: Mar. 12, 2021
(86) PCT No.: PCT/JP2021/010210

§ 371 Date: Sep. 28, 2022

(30) Foreign Application Priority Data
Mar. 31, 2020 (JP) 2020-062835

(51) Int. Cl. H02K 1/276; H02K 15/03

(52) U.S. Cl. CPC H02K 1/276; H02K 15/03

(57) ABSTRACT

A motor includes a rotor rotatable about a central axis and a stator opposing the rotor in a radial direction. The rotor includes an inner core extending along the central axis, a magnetic pole portions located radially outward of the inner core and arranged along a circumferential direction, and a holder holding the inner core and the magnetic pole portions. At least a portion of the magnetic pole portions includes two layers including a magnet and an outer core located radially outward or inward of the magnet and extending along the central axis. The holder includes a flange portion located on a one axial side of the inner core and the magnetic pole portions.

### CROSS REFERENCE TO RELATED APPLICATION

This is a U.S. national stage of application No. PCT/JP2021/010210, filed on Mar. 12, 2021, with priority under 35 U.S.C. § 119(a) and 35 U.S.C. § 365(b) being claimed from Japanese Patent Application No. 2020-062835, filed on Mar. 31, 2020, the entire disclosures of which being hereby incorporated herein by reference.

### 1. FIELD OF THE INVENTION

The present disclosure relates to a motor.

### 2. BACKGROUND

Typically, a motor includes a rotor and a stator. The rotor includes at least one magnet.

It is conceivable to suppress a cogging torque and a torque ripple in order to reduce the vibration and noise generated by the motor. Conventionally, a motor that reduces a cogging torque by providing step skew in a rotor or a stator is known.

Since a core of the rotor is configured by stacking electromagnetic steel plates in an axial direction, it is difficult to improve the dimensional accuracy in the axial direction. Further, as the core, an inner core and an outer core may be stacked in a radial direction and used. On the other hand, the magnet of the rotor needs to have a sufficient size in the axial direction in order to ensure sufficient magnetic characteristics. Therefore, it is assumed that the magnet and the outer core protrude to a one axial side with respect to the inner core in a case where an actual dimension of the inner core in the axial direction becomes small within a tolerance of a design dimension. If the rotor partially protrudes in the axial direction in a case where a plurality of the rotors are stacked in the axial direction, such as a case where step skew is provided in the rotors, there is a possibility that protruding portions interfere with each other, the overall axial dimension increases, so that it is difficult to obtain desired characteristics.

### SUMMARY

Example embodiments of the present disclosure provide motors each capable of suppressing each portion of a rotor from protruding in an axial direction.

A motor according to an example embodiment of the present invention includes a rotor rotatable about a central axis and a stator opposing the rotor in a radial direction. The rotor includes an inner core extending along the central axis, magnetic pole portions radially outward of the inner core and arranged along a circumferential direction, and a holder holding the inner core and the magnetic pole portions. At least a portion of the magnetic pole portions includes two layers including a magnet and an outer core located radially outward or inward of the magnet and extending along the central axis. The holder includes a flange portion located on a one axial side of the inner core and the magnetic pole portions. The flange portion includes a first opposing surface that opposes an end surface opposing the one axial side of the inner core, a second opposing surface that opposes an end surface opposing the one axial side of the outer core, and a third opposing surface that opposes an end surface opposing the one axial side of the magnet. The second opposing surface is located on the one axial side with respect to the first opposing surface and the third opposing surface.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a schematic sectional view of a motor of an example embodiment of the present disclosure in a cross section taken along a central axis.

FIG. 2 is a partial sectional view of the motor of the example embodiment in a cross section orthogonal to the central axis.

FIG. 3 is a perspective view of a rotor of the example embodiment.

FIG. 4 is a sectional view of the rotor of the example embodiment in a cross section passing through the central axis and an embedded magnetic pole portion.

FIG. 5 is a sectional view of the rotor of the example embodiment in a cross section passing through the central axis and an exterior magnetic pole portion.

FIG. 6 is a perspective view of the rotor of the example embodiment, and illustrates a state in which one embedded magnetic pole portion has been removed.

FIG. 7 is a perspective view of a rotor coupling body of the example embodiment.

FIG. 8 is a graph illustrating a waveform of cogging torque of the motor of the example embodiment.

FIG. 9 is a graph illustrating a waveform of a torque ripple of the motor of the example embodiment.

FIG. 10 is a sectional view of a rotor of a modification of an example embodiment of the present invention in a cross section passing through a central axis and an exterior magnetic pole portion.

### DETAILED DESCRIPTION

In the following description, an axial direction of a central axis J, that is, a direction parallel to the vertical direction, is simply referred to as the “axial direction”, a radial direction around the central axis J is simply referred to as the “radial direction”, and a circumferential direction around the central axis J is simply referred to as the “circumferential direction”. In the following example embodiment, a lower side (−Z) corresponds to a one axial side, and an upper side (+Z) corresponds to the other axial side. Note that the vertical direction, the upper side, and the lower side are simply names for describing a relative positional relationship of each portion, and an actual arrangement relationship or the like may be an arrangement relationship other than the arrangement relationships indicated by these names.

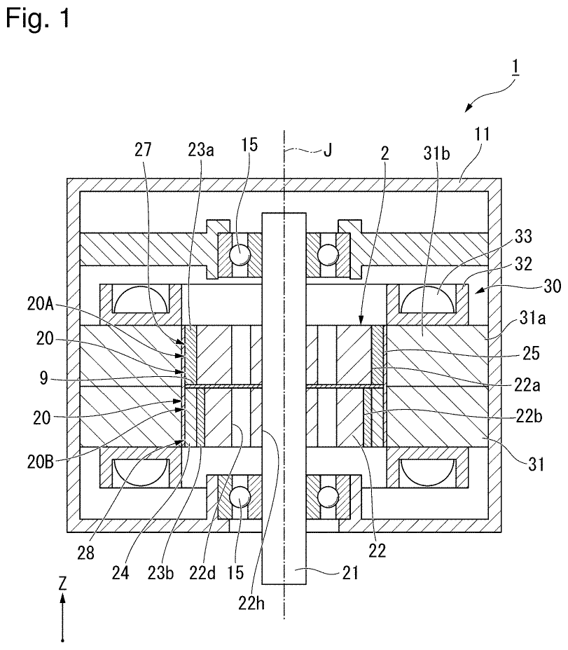

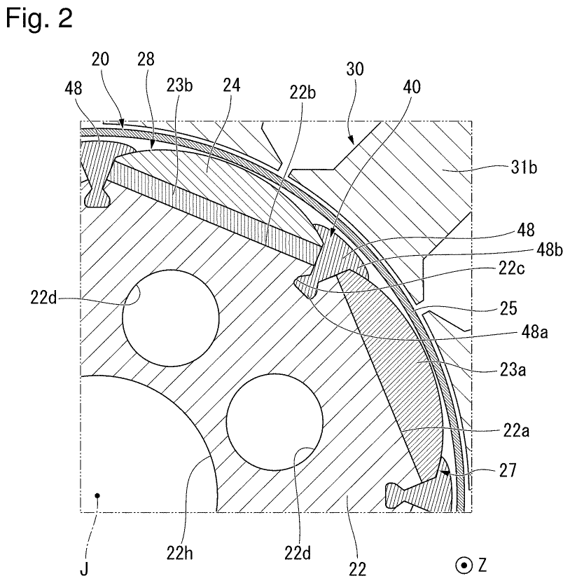

FIG. 1 is a schematic sectional view of a motor 1 in a cross section along the central axis J. FIG. 2 is a partial sectional view of the motor 1 in a cross section orthogonal to the central axis J.

As illustrated in FIG. 1, the motor 1 of the present example embodiment includes a rotor coupling body 2, a stator 30, a plurality of bearings 15, and a housing 11 accommodating these. The bearing 15 rotatably supports a shaft 21 of the rotor coupling body 2. The bearing 15 is held by the housing 11.

The stator 30 has an annular shape centered on the central axis J. The rotor coupling body 2 is arranged radially inward of the stator 30. The stator 30 opposes a pair of rotors 20 of the rotor coupling body 2 in the radial direction.

The stator 30 includes a stator core 31, an insulator 32, and a plurality of coils 33. The stator core 31 includes a plurality of electromagnetic steel plates stacked along the axial direction.

Specifically, the stator core 31 includes a substantially annular core back 31a and a plurality of teeth 31b. In the example embodiment, the core back 31a has an annular shape centered on the central axis J. The teeth 31b extend radially inward from a radially inner surface of the core back 31a. An outer peripheral surface of the core back 31a is fixed to an inner circumferential surface of a circumferential wall of the housing 11. The plurality of teeth 31b are arranged at intervals in the circumferential direction on the radially inner surface of the core back 31a. In the example embodiment, the plurality of teeth 31b are arranged at regular intervals in the circumferential direction.

The insulator 32 is attached to the stator core 31. The insulator 32 includes a portion covering the teeth 31b. For example, an insulating material such as a resin is used as a material for the insulator 32.

The coil 33 is attached to the stator core 31. The plurality of coils 33 are mounted to the stator core 31 with the insulator 32 interposed therebetween. The plurality of coils 33 are configured by winding a conductive wire around each of the teeth 31b with the insulator 32 interposed therebetween.

The rotor coupling body 2 includes the shaft 21, the pair of rotors 20 fixed to the shaft 21, a spacer 9 arranged between the pair of rotors 20, and a cover 25. The rotor coupling body 2 rotates about the central axis J. That is, the shaft 21, the pair of rotors 20, and the spacer 9 rotate about the central axis J. The shaft 21 has a columnar shape centered on the central axis J and extending in the axial direction. The cover 25 has a tubular shape centered on the central axis J. The cover 25 surrounds the pair of rotors 20 from the radially outside. The cover 25 is made of a non-magnetic material such as an aluminum alloy or a resin material.

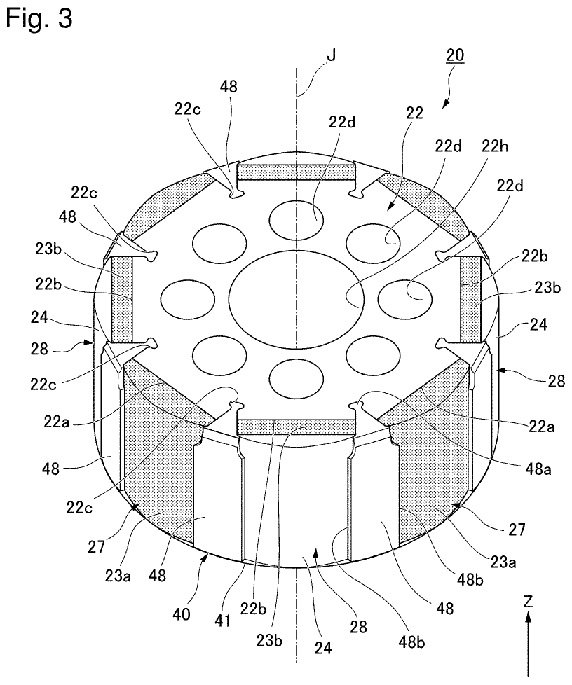

FIG. 3 is a perspective view of the rotor 20.

The rotor 20 includes an inner core 22, a plurality of magnetic pole portions 27 and 28 located radially outward of the inner core 22 and arranged along the circumferential direction, and a holder 40. Note that the pair of rotors 20 of the rotor coupling body 2 has the same configuration.

The inner core 22 extends along the central axis J. The inner core 22 has a substantially polygonal shape as viewed from the axial direction. The inner core 22 is provided with a central hole 22h and a plurality of hole portions 22d penetrating in the axial direction. The central hole 22h is located at the center as viewed from the axial direction. The plurality of hole portions 22d are arranged around the central hole 22h. The shaft 21 is inserted into and fixed to the central hole 22h. The hole portion 22d is provided to lighten the inner core 22 to reduce the weight of the inner core 22.

A plurality of (eight) flat portions 22a and 22b arranged along the circumferential direction and a plurality of (eight) grooves 22c located among the flat portions 22a and 22b are provided on an outer peripheral surface of the inner core 22 facing radially outward. The groove 22c extends over the entire axial length of the inner core. The groove 22c is open radially outward. The groove 22c has a wedge shape with a groove width decreasing toward the radially outside.

The flat portions 22a and 22b have flat shapes perpendicular to the radial direction. The flat portion 22a extends over the entire axial length of the inner core 22 in the axial direction. The eight flat portions 22a and 22b are classified into four first flat portions 22a and four second flat portions 22b. The first flat portion 22a and the second flat portion 22b are alternately arranged along the circumferential direction. The first flat portion 22a is arranged radially outward of the second flat portion 22b.

The eight magnetic pole portions 27 and 28 are classified into four exterior magnetic pole portions (first magnetic pole portions) 27 and four embedded magnetic pole portions (second magnetic pole portions) 28. The exterior magnetic pole portion 27 is arranged on the first flat portion 22a, and the embedded magnetic pole portion 28 is arranged in the second flat portion 22b. That is, the exterior magnetic pole portion 27 and the embedded magnetic pole portion 28 are alternately arranged along the circumferential direction of the central axis J.

The exterior magnetic pole portion 27 has an exterior magnet (magnet) 23a exposed to a radially outer surface. On the other hand, the embedded magnetic pole portion 28 has an embedded magnet (magnet) 23b and the outer core 24 covering the embedded magnet 23b from the radially outside. The exterior magnet 23a and the embedded magnet 23b are permanent magnets.

Note that the expression “the magnet is exposed radially outward” in the present specification means that the magnet is magnetically exposed radially outward. That is, it means that a member that affects flow of a magnetic flux of the magnet is not arranged between the magnet and the stator located radially outward of the magnet. Thus, the cover made of the non-magnetic material may be arranged between the magnet and the stator as illustrated in the present example embodiment.

As illustrated in FIG. 2, the exterior magnet 23a is arranged on a radially outer surface (the first flat portion 22a) of the inner core 22 in the exterior magnetic pole portion 27. The exterior magnet 23a is exposed radially outward. The exterior magnetic pole portion 27 can be referred to as a magnetic pole portion of a surface permanent magnet (SPM).

The exterior magnet 23a has a plate shape. The exterior magnet 23a has a quadrangular shape as viewed from the radial direction. The exterior magnet 23a has an arc shape in which a radially inner surface is linear and a radially outer surface projects radially outward as viewed from the axial direction. Thus, a radial thickness of the exterior magnet 23a increases from both circumferential ends toward the central side (circumferential inside). The radial inner surface of the exterior magnet 23a has a flat shape extending in a direction perpendicular to the radial direction. The radially outer surface of the exterior magnet 23a has a curved shape that is convex radially outward as viewed in the axial direction.

In the embedded magnetic pole portion 28, the embedded magnet 23b is arranged on a radially outer surface (the second flat portion 22b) of the inner core 22, and the outer core 24 is arranged on the radially outer surface of the embedded magnet 23b. That is, in the embedded magnetic pole portion 28, the embedded magnet 23b and the outer core 24 are arranged in this order from the second flat portion 22b to the radially outer side. The embedded magnet 23b is covered by the outer core 24, and the outer core 24 is exposed radially outward. Positions of both circumferential ends of the embedded magnet 23b and positions of both circumferential ends of the outer core 24 are arranged to overlap each other as viewed from the radial direction. The embedded magnetic pole portion 28 can be referred to as a magnetic pole portion of an interior permanent magnet (IPM).

The embedded magnet 23b has a plate shape. The embedded magnet 23b has a quadrangular plate shape. The embedded magnet 23b has a rectangular shape in which a length along the circumferential direction is larger than a length in the radial direction as viewed from the axial direction. Each of the radially inner surface and the radially outer surface of the embedded magnet 23b has the flat shape extending in the direction perpendicular to the radial direction.

The outer core 24 has a plate shape. The outer core 24 has a quadrangular shape as viewed from the radial direction. The outer core 24 has an arc shape in which a radially inner surface is linear and a radially outer surface is convex radially outward as viewed from the axial direction. Thus, a radial thickness of the outer core 24 increases from both the circumferential ends toward the central side (circumferential inside). The radially inner surface of the outer core 24 is a flat shape extending in the direction perpendicular to the radial direction. The radially outer surface of the outer core 24 has a curved surface convex radially outward as viewed in the axial direction.

As illustrated in FIG. 3, the holder 40 holds the inner core 22 and magnetic pole portions 27 and 28 to be embedded. The holder 40 is made of a resin material. In the present example embodiment, the holder 40 is molded by insert molding in which a part of the inner core 22 is embedded. Further, the plurality of magnetic pole portions 27 and 28 are fixed to the holder 40. In a process of molding the holder 40, the inner core 22 is held in a mold in a state where an upper end surface (end surface opposing the other axial side) 22j is in contact with the mold.

The holder 40 includes a flange portion 41 and a plurality of (eight in the present example embodiment) holding portions 48. The flange portion 41 is located on the lower side (one axial side) of the inner core 22 and the plurality of magnetic pole portions 27 and 28. The holding portion 48 extends in a columnar shape from the flange portion 41 toward the upper side (other axial side). The plurality of holding portions 48 are arranged at equal intervals along the circumferential direction. The exterior magnetic pole portion 27 or the embedded magnetic pole portion 28 is arranged between the holding portions 48 adjacent to each other in the circumferential direction.

As illustrated in FIG. 2, the holding portion 48 includes an anchor portion 48a and movement suppressing portions 48b. The groove 22c is filled with the molten resin and solidified, thereby forming the anchor portion 48a. A circumferential width of the anchor portion 48a increases toward the radially inner side. The movement suppressing portion 48b is located radially outward of the anchor portion 48a and connected to the anchor portion 48a. The movement suppressing portion 48b is arranged at a radially outer end of the holding portion 48. The movement suppressing portions 48b protrude from the anchor portion 48a toward both circumferential sides (one side and the other side), respectively. The movement suppressing portion 48b has a plate shape in which a plate surface is directed the radial direction.

According to the present example embodiment, the magnetic pole portion (the exterior magnetic pole portion 27 or the embedded magnetic pole portion 28) is press-fitted between the holding portions 48 arranged along the circumferential direction. That is, the plurality of holding portions 48 hold each of the magnetic pole portions 27 and 28 from both sides in the circumferential direction. According to the present example embodiment, since the wedge-shaped groove 22c is provided on the radially outer surface of the inner core 22, the holding portion 48 is suppressed from moving radially outward, and the holding portion 48 can be caused to function. Furthermore, the holding portion 48 can press the exterior magnetic pole portion 27 and the embedded magnetic pole portion 28 from the radially outer side by the movement suppressing portion 48b and can suppress the magnetic pole portions 27 and 28 from moving radially outward.

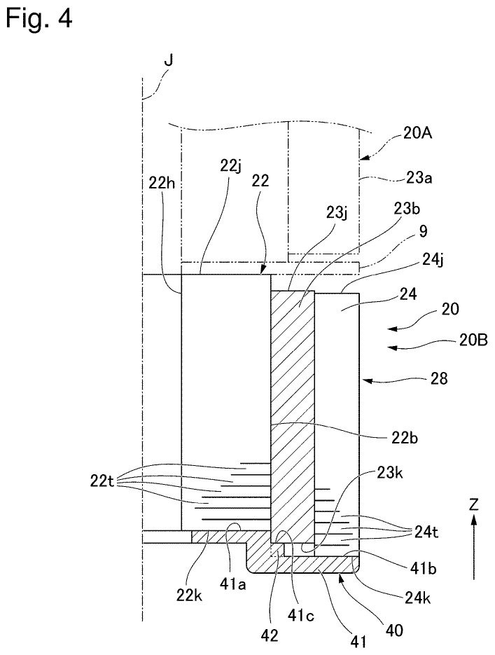

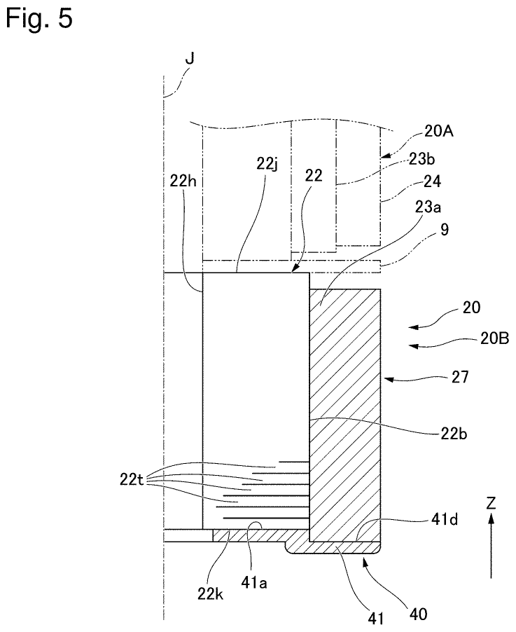

FIGS. 4 and 5 are sectional views of the rotor 20 in a cross section along the central axis J. The cross section in FIG. 4 passes through the central axis J and the embedded magnetic pole portion 28. Further, the cross section in FIG. 5 passes through the central axis J and the exterior magnetic pole portion 27. Note that the illustration of the hole portion 22d provided in the inner core 22 is omitted in FIGS. 4 and 5.

As illustrated in FIG. 4, the flange portion 41 has a first opposing surface 41a, a second opposing surface 41b, and a third opposing surface 41c which face upward (the other axial side) in the cross section passing through the central axis J and the embedded magnetic pole portion 28. In the cross section passing through the central axis J and the embedded magnetic pole portion 28, the first opposing surface 41a, the third opposing surface 41c, and the second opposing surface 41b are arranged in this order from the inner side to the outer side in the radial direction.

The first opposing surface 41a overlaps the inner core 22 as viewed from the axial direction. The first opposing surface 41a faces the lower end surface (end surface opposing the one axial side) 22k of the inner core 22. The holder 40 of the present example embodiment embeds the lower end surface 22k of the inner core 22. Thus, the first opposing surface 41a is in contact with the lower end surface 22k.

The second opposing surface 41b overlaps the outer core 24 as viewed from the axial direction. The second opposing surface 41b faces a lower end surface (end surface opposing the one axial side) 24k of the outer core 24. The second opposing surface 41b may be in contact with or separated from the lower end surface 24k of the outer core 24. The second opposing surface 41b is located on the lower side (one axial side) of the first opposing surface 41a and the third opposing surface 41c.

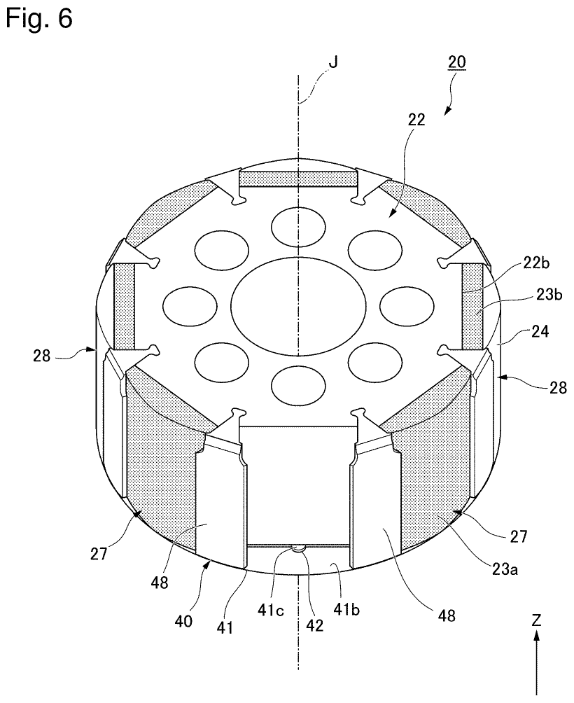

FIG. 6 is a perspective view of the rotor 20, and is a view illustrating a state in which one embedded magnetic pole portion 28 has been removed. As illustrated in FIG. 6, a part of the second opposing surface 41b extends to a region located immediately below the embedded magnet 23b.

The second opposing surface 41b is provided with a protrusion 42 protruding upward (to the other axial side). That is, the flange portion 41 has the protrusion 42 protruding upward from the second opposing surface 41b. The protrusion 42 is arranged at a radially inner end of the second opposing surface 41b. The protrusion 42 is located at the circumferential center of the second opposing surface 41b. The protrusion 42 has a semicircular shape as viewed from the axial direction. The third opposing surface 41c is provided on an upper surface of the protrusion 42. That is, the third opposing surface 41c is located at an upper tip (tip on the other axial side) of the protrusion 42.

As illustrated in FIG. 4, the third opposing surface 41c opposes a lower end surface (end surface opposing the one axial side) 23k of the embedded magnet 23b. The third opposing surface 41c may be in contact with or separated from the lower end surface 23k of the embedded magnet 23b.

In the present example embodiment, the inner core 22 includes a plurality of electromagnetic steel plates 22t stacked along the axial direction of the central axis J. Similarly, the outer core 24 has a plurality of electromagnetic steel plates 24t stacked along the axial direction of the central axis J. As a result, magnetic characteristics of the inner core 22 and the outer core 24 in a desired direction can be enhanced. In the present example embodiment, design dimensions of thicknesses of the electromagnetic steel plates 22t and 24t of the inner core 22 and the outer core 24 are the same. In addition, the number of stacked electromagnetic steel plates 22t in the inner core 22 and the number of stacked electromagnetic steel plates 24t in the outer core 24 are the same.

The electromagnetic steel plates 22t and 24t are formed by press working. Therefore, it is necessary to set dimensional tolerances of the inner core 22 and the outer core 24 to be large by piling up dimensional errors of thicknesses of base materials of the electromagnetic steel plates 22t and 24t in the axial direction. Further, in general, the electromagnetic steel plates 22t and 24t of the inner core 22 and the outer core 24 are made of the same type of steel plates, the dimensional tolerances of the inner core 22 and the outer core 24 are similarly set.

According to the present example embodiment, the second opposing surface 41b is located below the first opposing surface 41a. Therefore, even when an axial dimension of the outer core 24 is larger than an axial dimension of the inner core 22, an upper end surface 24j of the outer core 24 can be suppressed from protruding above the upper end surface 22j of the inner core 22.

A tolerance of an axial dimension of the embedded magnet 23b can be set to be smaller than those of the inner core 22 and the outer core 24. However, the embedded magnet 23b preferably has a certain axial dimension or more in order to ensure sufficient magnetic characteristics, and is unlikely to have a negative tolerance with respect to the inner core 22 and the outer core 24.

According to the present example embodiment, the third opposing surface 41c is located on the upper side of the second opposing surface 41b. Since the embedded magnet 23b can have a smaller dimensional tolerance in the axial direction as compared with the outer core 24, even when the third opposing surface 41c is arranged on the upper side of the second opposing surface 41b, the upper end surface 23j of the embedded magnet 23b can be suppressed from protruding above the upper end surface 22j of the inner core 22. Furthermore, since the third opposing surface 41c is located on the upper side of the second opposing surface 41b, the embedded magnet 23b can be arranged to overlap a wide range of the second flat portion 22b of the inner core 22, so that flow of a magnetic flux between the inner core 22 and the embedded magnet 23b can be made smoother.

According to the present example embodiment, the third opposing surface 41c is provided on the protrusion 42. Therefore, an area of the third opposing surface 41c can be reduced, and the dimensional accuracy of the entire third opposing surface 41c can be easily improved. Furthermore, a thickness of the flange portion 41 is not increased on the lower side of the third opposing surface 41c, and the generation of a sink mark in the flange portion 41 can be suppressed.

The third opposing surface 41c illustrated in FIG. 4 is located on the lower side of the first opposing surface 41a. Since the first opposing surface 41a is a surface that embeds the lower end surface 22k of the inner core 22, a relative axial position between the second opposing surface 41b and the third opposing surface 41c changes depending on an actual dimension of the inner core 22. Therefore, it is also conceivable that the third opposing surface 41c is located on the upper side of the first opposing surface 41a.

Here, the tolerances of the axial dimensions of the inner core 22 and the outer core 24 are each defined as ±D, and the tolerance of the axial dimension of the embedded magnet 23b is defined as ±d. Note that the dimensional tolerance of the embedded magnet 23b can be set to be smaller than those of the inner core 22 and the outer core 24, a relationship of D>d is established.

In a case where the actual axial dimension of the inner core 22 is the minimum within the tolerance, the third opposing surface 41c is arranged at a position of D+d on the lower side with respect to the first opposing surface 41a. In this case, the second opposing surface 41b is arranged at a position of 2D on the lower side with respect to the first opposing surface 41a.

When the actual dimension of the inner core 22 in the axial direction is the maximum within the tolerance, the third opposing surface 41c is arranged at the position D−d on the upper side with respect to the first opposing surface 41a. Further, in this case, the second opposing surface 41b is arranged at a position substantially coinciding with the first opposing surface 41a.

Note that a positional relationship between the second opposing surface 41b and the third opposing surface 41c in the axial direction is set such that the third opposing surface 41c is always arranged on the upper side of the second opposing surface 41b by d+D regardless of the actual dimension of the inner core 22.

The embedded magnetic pole portion 28 is press-fitted between the holding portions 48 arranged in the circumferential direction in the state of overlapping the outer core 24 and the embedded magnet 23b in the radial direction. In a process of press-fitting the embedded magnetic pole portion 28, the outer core 24 and the embedded magnet 23b are press-fitted until any one of the lower end surfaces 24k and 23k comes into contact with the flange portion 41. In a case where such a press-fitting process is adopted, at least one of the outer core 24 and the embedded magnet 23b comes into contact with the flange portion 41. When such a press-fitting process is adopted, the press-fitting process can be easily performed.

Note that a press-fitting process of press-fitting the outer core until the upper end surfaces 24j and 23j of the outer core 24 and the embedded magnet 23b reach the upper end surface 22j of the inner core 22 may be adopted. In this case, the lower end surfaces 24k and 23k of the outer core 24 and the embedded magnet 23b are separated from the flange portion 41. In a case where such a press-fitting process is adopted, the overlapping area among the inner core 22, the outer core 24, and the embedded magnet 23b as viewed from the radial direction can be increased, and the flow of the magnetic flux can be made smooth.

Assuming that the upper end surface 22j of the inner core 22 is a reference surface in the present example embodiment, the upper end surfaces (surfaces opposing the other axial side) 24j and 23j of the outer core 24 and the embedded magnet 23b are located on the lower side (one axial side) of the reference surface 22j. According to the present example embodiment, the outer core 24 and the embedded magnet 23b do not protrude upward from the reference surface 22j of the inner core 22 on the opposite side of the flange portion 41. Thus, when another member is arranged on the upper side of the rotor 20 with reference to the reference surface 22j, interference between the other member and each of the outer core 24 and the embedded magnet 23b can be suppressed.

More specifically, when the spacer 9 is arranged in contact with the reference surface 22j, interference between the spacer 9 and each of the outer core 24 and the embedded magnet 23b can be suppressed, and an increase in axial dimension of the rotor coupling body 2 can be suppressed.

As illustrated in FIG. 5, in the cross section passing through the central axis J and the exterior magnetic pole portion 27, the flange portion 41 has the first opposing surface 41a and a fourth opposing surface 41d facing upward (the other axial side). In the cross section passing through the central axis J and the exterior magnetic pole portion 27, the first opposing surface 41a and the fourth opposing surface 41d are arranged in this order from the inner side to the outer side in the radial direction.

The fourth opposing surface 41d overlaps the exterior magnet 23a as viewed from the axial direction. The fourth opposing surface 41d opposes a lower end surface of the exterior magnet 23a. The fourth opposing surface 41d may be in contact with or separated from the lower end surface of the exterior magnet 23a. The fourth opposing surface 41d is located on the lower side of the first opposing surface 41a. According to the present example embodiment, it is possible to suppress the exterior magnet 23a from protruding upward from the upper end surface (reference surface) 22j of the inner core 22 on the opposite side of the flange portion 41. Thus, when the spacer 9 is arranged in contact with the reference surface 22j, interference between the spacer 9 and the exterior magnet 23a can be suppressed, and the increase in the axial dimension of the rotor coupling body 2 can be suppressed.

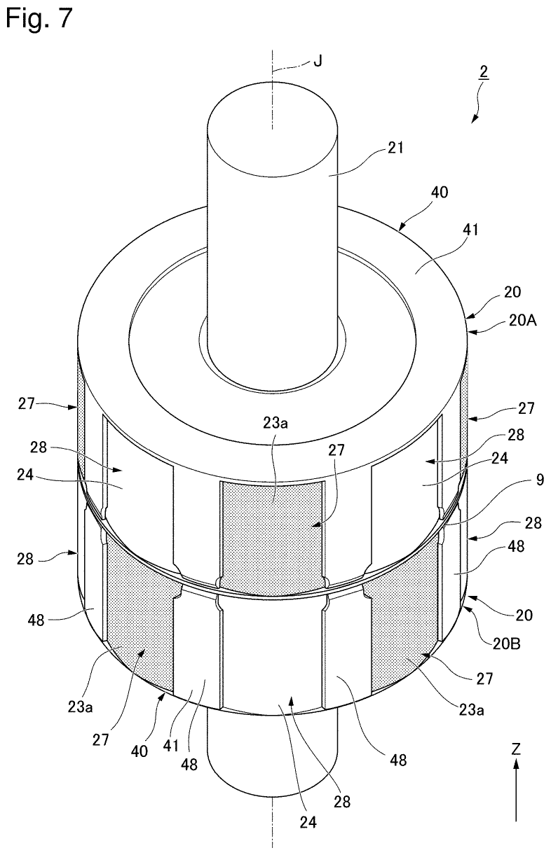

FIG. 7 is a perspective view of the rotor coupling body 2 of the present example embodiment.

In the rotor coupling body 2, the pair of rotors 20 are stacked in the axial direction with the flange portions 41 arranged on the opposite axial sides. Further, the spacer 9 is arranged between the pair of rotors 20.

In the following description, in a case where the pair of rotors 20 are distinguished from each other, one arranged on the upper side is referred to as a first rotor 20A, and the other arranged on the lower side is referred to as a second rotor 20B. In the first rotor 20A, the flange portion 41 of the holder 40 is arranged on the upper side of the inner core 22 and the magnetic pole portions 27 and 28. On the other hand, in the second rotor 20B, the flange portion 41 of the holder 40 is arranged on the lower side of the inner core 22 and the magnetic pole portions 27 and 28.

As illustrated in FIG. 7, the first rotor 20A and the second rotor 20B are arranged such that the exterior magnetic pole portion 27 and the embedded magnetic pole portion 28 are shifted in the axial direction. The embedded magnetic pole portion 28 of the second rotor 20B is arranged on the lower side of the exterior magnetic pole portion 27 of the first rotor 20A. Further, the exterior magnetic pole portion 27 of the second rotor 20B is arranged on the lower side of the embedded magnetic pole portion 28 of the first rotor 20A. That is, the exterior magnetic pole portion 27 of one of the pair of rotors 20 and the embedded magnetic pole portion 28 of the other of the pair of rotors 20 are arranged side by side in the axial direction. A circumferential center of the exterior magnetic pole portion 27 of one rotor 20 and a circumferential center of the embedded magnetic pole portion 28 of the other rotor 20 are arranged so as to overlap each other. In this manner, the magnets (the exterior magnet 23a and the embedded magnet 23b) of the present example embodiment are arranged straight in the axial direction without applying skew.

In the same rotor 20, the exterior magnetic pole portion 27 and the embedded magnetic pole portion 28 have mutually different magnetic poles facing radially outward. Further, the exterior magnetic pole portion 27 and the embedded magnetic pole portion 28 arranged in the axial direction have the same magnetic pole facing radially outward. For example, the exterior magnetic pole portion 27 of the first rotor 20A and the embedded magnetic pole portion 28 of the second rotor 20B have an N pole facing radially outward, and the embedded magnetic pole portion 28 of the first rotor 20A and the exterior magnetic pole portion 27 of the second rotor 20B have an S pole facing radially outward.

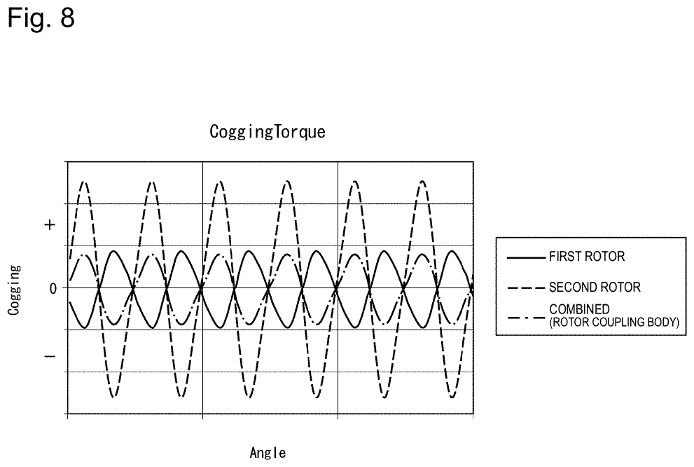

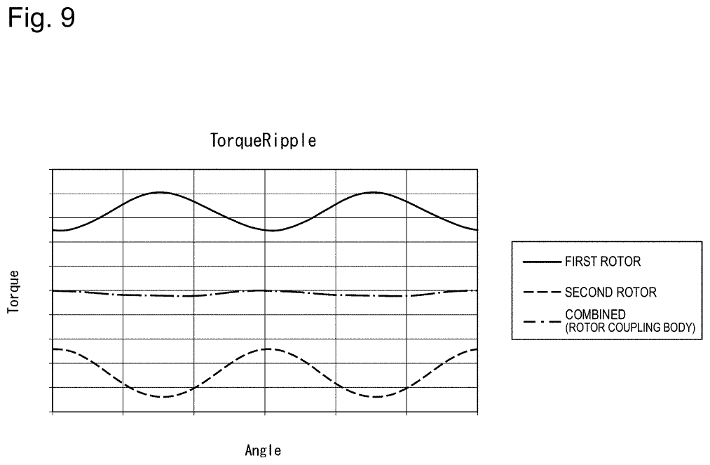

FIG. 8 is a graph illustrating a waveform of cogging torque of the motor 1 of the present example embodiment. FIG. 9 is a graph illustrating a waveform of a torque ripple of the motor 1 of the example embodiment. As illustrated in FIG. 8 and FIG. 9, in the example embodiment, opposite phases can be generated in the cogging torque without applying skew to the magnets (the exterior magnet 23a and the embedded magnet 23b). That is, the cogging torque generated in a first rotor 20A and the cogging torque generated in a second rotor 20B are generated with phases opposite to each other, and thus, cancel each other, so that a fluctuation range of a combined cogging torque waveform (a difference between a maximum value and a minimum value of the combined cogging torque) can be kept small. The opposite phase can be generated in the torque ripple. That is, because the torque ripple generated in the first rotor 20A and the torque ripple generated in the second rotor 20B are generated with phases opposite to each other, the torque ripple generated in the first rotor 20A and the torque ripple generated in the second rotor 20B cancel each other, and a fluctuation range of a combined torque ripple waveform (the difference between the maximum value and the minimum value of the combined torque ripple) can be suppressed to be small. Thus, the cogging torque can be reduced while suppressing the torque reduction, and the torque ripple can be reduced. Then, the vibration and noise generated by the motor 1 can be reduced.

### Modification

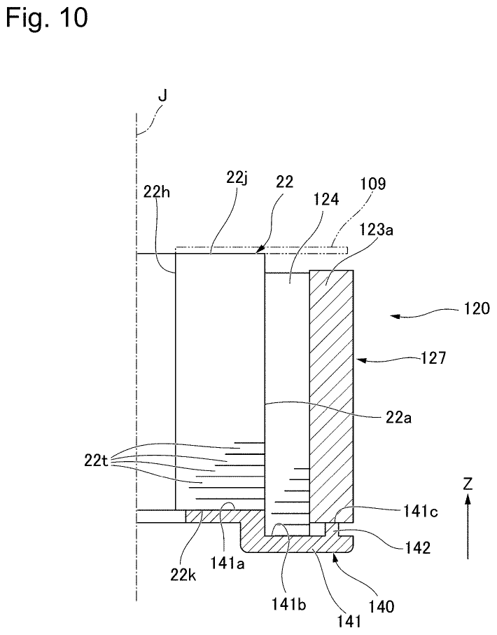

In the above-described example embodiment, the exterior magnetic pole portion 27 includes only the exterior magnet 23a. However, an exterior magnetic pole portion 127 may include an outer core 124 located radially inward of an exterior magnet 123a as illustrated in FIG. 10 as a modification.

Note that a constituent element of the identical aspect to that of the above-described example embodiment is denoted by the same reference sign, and the description thereof will be omitted.

As illustrated in FIG. 10, a holder 140 of a rotor 120 of the modification has, on a flange portion 141, a first opposing surface 141a, a second opposing surface 141b, and a third opposing surface 141c. In a cross section passing through the central axis J and the exterior magnetic pole portion 127, the first opposing surface 141a, the second opposing surface 141b, and the third opposing surface 141c are arranged in this order from the radially inner side to the radially outer side. The first opposing surface 141a opposes a lower end surface 22k of the inner core 22. The second opposing surface 141b opposes a lower end surface of the outer core 124. The third opposing surface 141c opposes a lower end surface of the exterior magnet 123a. Further, the flange portion 141 has a protrusion 142 protruding upward from the second opposing surface 141b, and the third opposing surface 141c is located at an upper tip of the protrusion 142. The second opposing surface 141b is located on the lower side of the first opposing surface 141a and the third opposing surface 141c.

According to the present modification, the second opposing surface 141b is located on the lower side of the first opposing surface 141a. Therefore, even when an axial dimension of the outer core 124 is larger than an axial dimension of the inner core 22, an upper end surface of the outer core 124 can be suppressed from protruding above the upper end surface 22j of the inner core 22. Further, the third opposing surface 141c is located on the upper side the second opposing surface 141b according to the present modification. Since the exterior magnet 123a can have a smaller dimensional tolerance in the axial dimension as compared with the outer core 124, even when the third opposing surface 141c is arranged on the upper side of the second opposing surface 141b, the upper end surface of the exterior magnet 123a can be suppressed from protruding above the upper end surface 22j of the inner core 22. Furthermore, since the third opposing surface 141c is located on the upper side of the second opposing surface 141b, the exterior magnet 123a can be arranged to overlap a wide range of the first flat portion 22a of the inner core 22, so that flow of a magnetic flux between the inner core 22 and the exterior magnet 123a can be made smoother.

According to the present modification, the exterior magnet 123a does not protrude upward from the upper end surface (reference surface) 22j of the inner core 22 on the opposite side of the flange portion 141. Thus, when a spacer 109 is arranged in contact with the reference surface 22j, interference between the spacer 109 and each of the outer core 124 and the exterior magnet 123a can be suppressed, and an increase in axial dimension of the rotor coupling body 2 can be suppressed. Note that an outer diameter of the spacer 109 of the present modification is smaller than an outer diameter of the exterior magnet 123a. In this manner, a shape of the spacer 109 is not limited as long as having a size that overlaps the magnet and the outer core of each magnetic pole portion as viewed from the axial direction.

As illustrated in the above-described example embodiment and modification, it suffices that the magnetic pole portion opposing the second opposing surface and the third opposing surface has two layers including the magnet and the outer core that is located on the outer side and the inner side of the magnet in the radial direction and extends along the central axis.

Although the example embodiment of the present invention and the modification thereof have been described above, the respective configurations and combinations thereof in the example embodiment and the modification are merely examples, and therefore addition, omission, substation and other variations of the configurations can be made within the scope not departing from the gist of the present invention. Further, the present invention is not to be limited by the example embodiment and the modification thereof.

For example, the shapes of the magnets and the shapes of the outer cores are not limited to the examples described in the above-described example embodiment and modification. Further, the number of poles of the rotor and the number of slots of the stator are not limited to those of the above-described example embodiment. Additionally, features of the above-described preferred embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-7. (canceled)

8. A motor comprising:
a rotor rotatable about a central axis; and
a stator opposing the rotor in a radial direction; wherein
the rotor includes:
an inner core extending along the central axis;
magnetic pole portions radially outward of the inner core and arranged along a circumferential direction; and
a holder holding the inner core and the magnetic pole portion;
at least a portion of the magnetic pole portions includes two layers including a magnet and an outer core located radially outward or inward of the magnet and extending along the central axis;
the holder includes a flange portion located on one axial side of the inner core and the magnetic pole portions;
the flange portion includes:
a first opposing surface that opposes an end surface opposing the one axial side of the inner core;
a second opposing surface that opposes an end surface opposing the one axial side of the outer core; and
a third opposing surface that opposes an end surface opposing the one axial side of the magnet; and
the second opposing surface is located on the one axial side with respect to the first opposing surface and the third opposing surface.

9. The motor according to claim 8, wherein
the flange portion includes a protrusion protruding to another axial side from the second opposing surface; and
the third opposing surface is located at a tip on the other axial side of the protrusion.

10. The motor according to claim 8, wherein at least one of the outer core and the magnet is in contact with the flange portion.

11. The motor according to claim 8, wherein the holder includes holding portions extending from the flange portion to another axial side and holding the magnetic pole portions from two circumferential sides.

12. The motor according to claim 8, wherein the inner core and the outer core include electromagnetic steel plates stacked along an axial direction of the central axis.

13. The motor according to claim 8, wherein a surface opposing the other axial side of the inner core is a reference surface, and surfaces opposing the other axial side of the outer core and the magnet are located on the one axial side with respect to the reference surface.

14. The motor according to claim 8, further comprising:
a pair of the rotors stacked in the axial direction with a pair of the mutual flange portions on opposite axial sides; and
a spacer between the pair of rotors; wherein
the magnetic pole portions include:
a first magnetic pole portion in which the magnet is exposed to a radially outer surface; and
a second magnetic pole portion in which the outer core covers the magnet;
the first magnetic pole portion and the second magnetic pole portion are alternately arranged along the circumferential direction of the central axis; and
the first magnetic pole portion of one of the pair of rotors and the second magnetic pole portion of another of the pair of rotors are arranged side by side in the axial direction.
